(19) United States
(12) Patent Application Publication
(10) Pub. No.: US 2019/0308917 A1
(43) Pub. Date: Oct. 10, 2019

(54) METHOD FOR PREPARING SOIL AMENDMENT

(71) Applicant: Charles Wood, Abilene, TX (US)

(72) Inventor: Charles Wood, Abilene, TX (US)

(21) Appl. No.: 15/946,533

(22) Filed: Apr. 5, 2018

(51) Int. Cl. C05G 3/04; C09K 17/14; C05F 11/10

(52) U.S. Cl. CPC C05G 3/04; C09K 2101/00; C05F 11/10; C09K 17/14

(57) ABSTRACT

A method for producing soil amendment is disclosed. The method comprising: In the first step, different parts of a mesquite tree are collected. The collected parts comprises leaves, trunk, beans, mistletoe, roots and branches. In the second step, the collected parts are organized based on nutrient level. In the third step, the collected parts are dried. In the fourth step, the dried parts are milled to obtain a powder material of desired size. The powder material obtained is applied to a soil to improve the physical constitution of the soil.

### BACKGROUND OF THE INVENTION

### A. Technical field

The invention disclosed herein generally relates to soil management. More particularly, the invention disclosed herein relates to a method for preparing soil amendment.

### B. Description of related art

Soil is an important constituent to support plant life. A number of factors are important in determining the ability of the soil to support the plant life, such as the presence of humus and organic matter, essential elements, the ability to retain water, pH and mineralization among others. Further, the soil used for cultivating different plants must have proper organic and carbohydrate content.

Although soil plays a vital role in plant growth, certain soils fail to support plant growth. The soil forming hard aggregates, which are difficult to break fail to hold water and are readily dried out during dry seasons. The growth of the plants in such soil is inhibited and cultivation of crops is difficult. The soil containing a high percentage of clay includes the aforementioned features. The clay soil forms such a hard, packed crust that the spread of plant roots is retarded, and the penetration of moisture from rainfall is prevented. To address the aforementioned problem, soil amendments are used in the present days. However, the soil amendments used are highly expensive and have failed to provide satisfactory results.

Recently, the use of synthetic resins, such as the polyacrylonitriles, has been recommended for this purpose, and their use has been followed with a high degree of success. However, these resin preparations are relatively costly. In light of the foregoing discussion, there is a need of a soil amendment that could improve the physical constitution of the soil at relatively low cost with high efficiency.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

A method for preparing a soil amendment is disclosed. The method comprising: In the first step, different parts of a mesquite tree are collected. The collected parts comprises leaves, trunk, beans, mistletoe, roots and branches. In the second step, the collected parts are organized based on nutrient level. In the third step, the collected parts are dried, after the completion of the cleaning process. In the fourth step, the dried parts are milled to obtain a powder material of desired size. The powder material obtained is applied to a soil to improve the physical constitution of the soil.

In an embodiment, the mesquite tree is selected from Prosopis glandulosa, Prosopis pubescens, and Prosopis velutina. In another embodiment, different ratio of the collected parts are grounded together to obtain the powder material. In some embodiments, each of the collected parts are grounded separately to obtain powder material. The powdered material obtained from the each of the collected parts are then mixed together. The powder material obtained is used as the soil amendment to rebuild the soil. The soil amendment of the present invention is mesquite based soil amendment. The soil amendment of the present invention when applied to the soil helps in water retention.

### BRIEF DESCRIPTION OF THE DRAWINGS

The foregoing summary, as well as the following detailed description of the invention, is better understood when read in conjunction with the appended drawing. For illustrating the invention, exemplary constructions of the invention is shown in the drawing. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a method flowchart showing the steps involved in the production of soil amendment.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

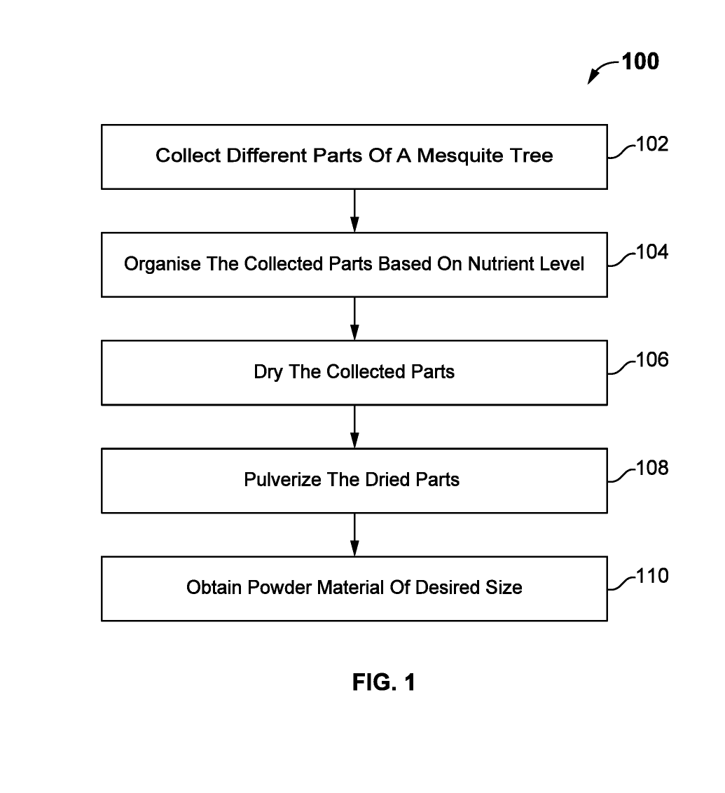

FIG. 1 exemplarily illustrates a method flowchart 100 showing the steps involved in the preparation of a soil amendment. At step 102, different parts of a mesquite tree is collected. The different parts of the mesquite tree comprises leaves, trunk, beans, mistletoe, roots and branches. The aforementioned parts of the mesquite tree are collected separately. At step 104, the collected parts of the mesquite tree is organized based on nutrient levels. At step 106, the collected parts of the mesquite tree are dried to remove the moisture absorbed. After the completion of the drying process, the parts of the mesquite tree is pulverized at step 108. The pulverization process is carried out for a predetermined time. The pulverization process is continued until the collected parts are grinded to obtain a powder material or powder form of desired size. At step 110, the powdered material of the collected parts are obtained. The powdered material obtained is used as soil amendment. The soil amendment obtained in the present invention is an organic amendment. The soil amendment of the present invention helps in improving the physical nature of the soil used for growing trees or plants. In an embodiment, the soil amendment helps in rebuilding the soil. Further, in another embodiment, the soil amendment of the present invention helps in water retention or conservation of water providing a healthy environment for the trees or plants to grow.

In an embodiment, the different parts of the mesquite tree is collected. The collected parts include for example but not limited to the leaves, the trunk, the beans, the mistletoe, the roots and the branches. The mistletoe in the mesquite tree are species of a plant that grow on the mesquite tree. In one embodiment, the stems, the branches, the trunk, the beans are sliced, as these parts are larger, and could cause problems or difficulty during the pulverization process. In an embodiment, the collected parts of the mesquite tree are chipped separately. The collected parts are chipped to facilitate the milling process. All the parts of the mesquite tree are to be processed through a chipper or any other means that serves the purpose of the present invention. The smaller parts such as the leaves, small branches, mistletoe and bean pods are immediately processes through the chipper in the area of harvest as it would be impossible to ship the leaves, small branches etc. back to the process unprocessed. However, the larger and heavier parts of the mesquite tree are transported to the manufacturing unit. The larger and heavier parts of the mesquite tree are chipped at the manufacturing unit.

In an embodiment, the collected parts are organized based on nutrient level of the parts of the mesquite tree, after the completion of the above step. The level of nutrients present varies among the collected parts. The parts having highest level of nutrients are the mistletoe and bean pods. The leaves and small branches have nutrient levels lesser than mistletoe and bean pods. The lowest level of nutrients are found in the trunks.

In the next step, the parts of the mesquite tree are dried. In an embodiment, a mechanical drying technique is used for drying the collected parts. The mechanical drying process is usually preferred for large scale processing. In mechanical processing, hot air dryers or electric dryers are used for drying. The temperature maintained with the mechanical dryers should be such that the parts kept for drying are not destroyed or burnt. In one embodiment, the technique used for drying the parts of the mesquite tree is room drying. The technique used for drying the collected parts are the techniques well known in the prior art. The objective of the drying technique is to obtain the collected parts in brittle form. The brittle form of the collected parts facilitates in obtaining the powder material or powder form of the collected parts. The moisture content present in the collected parts plays a vital role in the pulverization process. It is desirable to reduce the moisture content present in the collected parts to the desired level by the technique disclosed above. The drying technique known in the prior art could also be employed if it serves the objective of the present invention.

The final step involved in the method 100 is the pulverization process or a milling process. In an embodiment, each of the parts of the mesquite tree are separately pulverized, crushed, milled or grinded in a pulverizer. In another embodiment, all the parts of the mesquite tree in different ratio are grounded together. In some embodiments, any combination of the parts is grounded together. For example, the branches and the trunk. The parts after the pulverization process are obtained in the form of the powdered material having the desired size. The smaller the size of the powdered material, faster is the decomposition of the powdered material into the soil. The powdered material having larger particle size takes a longer time to decompose into the soil and hence, the desired nutrients are released at a slower rate. The pulverization process is performed in the pulverizer or any machine that facilitates the grinding of the parts of the mesquite tree to obtain the powdered material. The machine used for grinding or pulverizing is for example but not limited to a hammer mill or a grinder machine. The powder obtained in the final step is used as the soil amendment. The powder obtain is applied or sprinkled on a soil, to improve the physical constitution of the soil. The moisture content present in the collected parts should be less or negligible to facilitate the rate of pulverization process. The collected parts having the moisture content of 28% produces the powder material at 5 ton/hour rate. However, the rate of production of the powder material increases as the moisture content in the collected parts are reduced. For example, the collected parts having 17% moisture content produces the powder material at a rate of 12 ton/hour. In an embodiment, each of the parts are grinded separately and the powder obtain from the each of the grinded parts are mixed together prior to applying the powder material on the soil. In some embodiments, various combination of the powdered material obtained from each of the collected parts could be used. In various embodiments, the soil amendment is produced by grinding only the single part of the mesquite tree, for example but not limited to leaves. In some embodiments, the mistletoe and bean pods are grinded or milled together. In an embodiment, the final or desired size of the powdered material obtained at the end of the milling process could vary. The powdered material obtained is of large size, if it is to be added to the soil of a garden. However, the desired size of the powdered material should be smaller, when applied on golf green area.

In an embodiment, the soil amendment of the present invention is the mesquite tree-based soil amendment. Three common species of the mesquite tree is Prosopis glandulosa, Prosopis pubescens, and Prosopis velutina. In one embodiment, the mesquite tree used in the present invention is Prosopis glandulosa. In another embodiment, the mesquite tree used in the present invention is Prosopis pubescens. In some embodiments, the mesquite tree used in the present invention is Prosopis velutina. The powder obtained in the final step of the method 100, is applied on the soil. The mesquite tree is a nitrogen fixer and modifies the soil fertility. Hence, the various parts of the mesquite tree is used for producing the soil amendment by the process disclosed in the present invention. Based on the type of soil selected to improve the physical constitution, the parts of the mesquite tree are selected accordingly, to prepare the soil amendment by the method disclosed in the present invention. The soil amendment of the present invention is used in planting, gardening, treating soil, and farming.

Periodical observations are made regarding the growth rate, leaf color, flower size and abundance, wilting, disease tolerance and plant size of the plants grown in the soil treated with the soil amendment of the present invention. The plants growing in the soil amendment of this invention exhibited the same degree of health and bloom as those growing in the other types of soil amendments known in the prior art.

The foregoing examples have been provided merely for the purpose of explanation and are in no way to be construed as limiting of the method 100, disclosed herein. While the method 100 has been described with reference to various embodiments, it is understood that the words, which have been used herein, are words of description and illustration, rather than words of limitation. Further, although the method 100 has been described herein with reference to particular means, materials, and embodiments, method 100 is not intended to be limited to the particulars disclosed herein; rather, the method 100 extends to all functionally equivalent structures, methods and uses, such as are within the scope of the invention. Although there has been shown and described the preferred embodiment of the present invention, it will be readily apparent to those skilled in the art that modifications may be made thereto.

What is claimed is:

1. A method for preparing a soil amendment, the method comprising:
a) collecting different parts of a mesquite tree;
b) organizing the collected parts based on nutrient level;
c) drying the collected parts, and
d) milling the dried parts to obtain a powder material of desired size.

2. The method of claim 1, wherein the collected parts comprises leaves, trunk, beans, mistletoe, roots and branches.

3. The method of claim 1, wherein different ratio of the collected parts are milled together.

3. The method of claim 1, wherein the parts milled together are leaves and the trunk.

4. The method of claim 1, wherein the parts milled together are roots and branches.

5. The method of claim 1, wherein the parts milled together are beans and mistletoe.

6. The method of claim 1, wherein the mesquite tree is selected from Prosopis glandulosa, Prosopis pubescens, and Prosopis velutina.

7. The method of claim 1, further comprising applying the powder material having the desired size to a soil.
